(19) United States
(12) Patent Application Publication
(10) Pub. No.: US 2009/0151262 A1
(43) Pub. Date: Jun. 18, 2009

(54) DOOR OPENER

(75) Inventor: Michael Kevin Scheib, Auckland (NZ)

Correspondence Address: FITCH EVEN TABIN AND FLANNERY, 120 SOUTH LASALLE STREET, SUITE 1600, CHICAGO, IL, 60603-3406, US

(73) Assignee: ANZON AUTODOOR LIMITED, Auckland (NZ)

(21) Appl. No.: 11/572,401

(22) PCT Filed: Jul. 21, 2005
(86) PCT No.: PCT/NZ2005/000184

§ 371 Date: Nov. 3, 2008

(30) Foreign Application Priority Data
Jul. 21, 2004 (NZ) 534277

(51) Int. Cl. E05F 15/10; E05F 11/54

(52) U.S. Cl. 49/349; 49/358

(57) ABSTRACT

A narrow door opener which has a capability of being mounted in a small space between the end of a door roll of, for example, a curtain door and any impediment spaced therefrom. The door opener has on its flank a waisted region to accommodate a mounting bracket below the axle axis of the door roll to be opened thereby. The flank to flank distance (not counting door roll engagement features) is less than 200 mm and preferably less than 100 mm.

The present invention relates to door openers, door opening arrangements and related assemblies, components and methodologies.

Door openers are manufactured and supplied for use in a number of situations.

Door openers such as those that might be used for curtain, sectional or tilt garage or the like doors frequently employ a logic controlled DC or an AC motor to drive the movement of the door through a transmission. The transmission may be to a rotating shaft of a curtain door or a tambour type door or to a tracked carriage associated with a sectional or tilt door.

In many existing garage door assemblies the transmission includes a flexible driving element such as a chain or belt. Therefore one of the components of the drive train is usually a sprocket or pulley.

Hitherto drive assemblies utilising a carried electric motor has involved the difficulty of aligning the motor so as to have an output shaft in concert or parallel to that of the sprocket or pulley rotational axis (whether through a reduction gearbox or otherwise) to derive power therefrom or, and this is more usual, requires some transmission capable of allowing the rotational axis of the motor to be disposed at some oblique or right angle to the rotational axis of the sprocket or pulley. See PCT/NZ2003/000211.

There are many instances where a drive system for such door systems requires calibration so as to ensure that the electric motor (or other prime mover) does not continue to drive or drive effectively in its application beyond limits of that application. For example, in the situation with, for example, garage doors, whether of the curtain, tilt or sectional types it is usual (irrespective of whether or not AC or DC motors are being used as the motive force) to provide limits whereby there is a cut-off of the energising power to the motor when the door is either fully open or fully closed.

Frequently such cut-off systems are dependent upon manual inputs by way of screws or the like members that allow the limits to be customised for the particular application.

Our PCT/NZ2003/00212 relates to apparatus and related procedures and the like that has application inter alia in such applications as the limit control of, for example, garage doors but has more widespread application.

The full content of our patent specifications PCT/NZ2003/000211, PCT/NZ2003/000212 and PCT/NZ2003/0013 is herein included, as are all published information on our existing MERLIN™ brand door opener systems particularly to show the background art and also what we hereinafter refer to as control and limit functionalities.

The present invention recognises irrespective of motor rotation axis orientation a desirability for an opener capable of rotating a door element (e.g. such as that of a curtain or other such door) where it must provide an output drive member that rotates in concert with the central axis of the roll of the curtain door or the equivalent yet which may need to be installed and/or be serviceable in a small gap between the end of the door roll and some structural member of the building having the door opening to be closed or opened.

It is also an object of the present invention (some instances an alternative to the aforementioned object) to make provision for support of such a door opener from a mount outstanding from the building or other support but extending as an arm or other structure to the door opener in a direction which is in a plane normal to the rotational axis of the door roll and/or the output drive member.

In yet a further aspect the present invention consists in a door opener and/or a mounting of a door opener and related assemblies where a mounting bracket notwithstanding space availability is allowed to be positioned as close to the door to be opened as is possible, e.g. preferably this is achieved by reliance upon a waisting of the door opener from one side thereof normal to the rotational axis to the door to be open such that the waist can accommodate as a support for the door opener and/or the carried axial for the door a component of the mounting bracket.

In one aspect the present invention consists in a door opener which has a capability of being mounted in a small space between the end of a door roll of, for example, a curtain door and any impediment spaced therefrom, such door opener having provision whereby despite its need for mounting and/or its lateral extent in the direction of the rotational axis of its output drive member is and will be less than 200 mm and preferably the expanse of the unmounted opener itself is less than 150 mm.

In another aspect the invention consists in a door opener of a kind having a rotatable output member adapted to engage a door to be opened or closed, said output member having an axis of rotation which in use will be at least substantially horizontal and transverse to the longitudinal extent thereof which is in use will be substantially vertical,

wherein the opener has its transverse extent in that direction parallel to said axis of rotation less than its transverse extent normal thereto and less than its longitudinal extent,

and wherein on that flank of the opener opposite the flank with the output member there is a waisting at a region adapted to receive a or the mount for the opener.

Preferably the transverse extent parallel to said axis of rotation is less than 150 mm.

In another aspect the invention is a door opening arrangement including

a (cored, spooled, axled or equivalent) curtain door assembly capable of being rotatably unwound and wound, thereby to close and open respectively a door opening of a building,

a door opener engaging an end of the curtain door assembly capable of being initiated to cause the curtain door assembly to unwind and/or wind, and

a mount for the door opener from the building

wherein the door opener has a lateral parallel to the wind/unwind axis of the curtain door assembly less than 150 mm.

Preferably the mount is into a waisted region of one flank of the door opener.

In another aspect the invention consists in a door opener adapted to open and/or close or allow to close a curtain door, the door opener having at least:

at least partial housing assembly that includes support (directly or indirectly) for the remaining features (“the assembly”),

a sun gear carried by the assembly,

a drive member or members to rotate as the sun gear rotates and adapted externally of the assembly to engage and to rotate a complementary door curtain assembly,

a pinion adapted to rotate the sun gear,

an electric motor,

a transmission from the motor to the pinion by which the pinion rotates responsive to motor movement, and

control and limit functionalities for the motor, the transmission and/or the sun gear/pinion interaction whereby the drive of the sun gear, one way and/or the other in a rotational sense, and (optionally) the limiting of rotation thereof in at least one rotational sense, is caused, allowed and/or controlled by (a) signal inputs alone or (b) a mixture of set up input(s) and signal input(s),

wherein the assembly allows for an inset support thereof (e.g. by a complementary mount) at least in part under part of the assembly when, as is desired, the sun gear of the door opener is to be oriented such that it rotates about a substantially horizontal axis,

and wherein the greatest dimensional extent of the opener in a direction parallel to the rotational axis of the sun gear from the exterior of the sun gear (ignoring the drive member(s)) to the other side of the opener is less than 150 mm.

Preferably the greatest extent is from 125 to 85 mm.

Preferably the greatest extent is from 110 mm to 90 mm.

Preferably the greatest extent is about 100 mm.

Preferably the drive member(s) includes one or more dogs, fingers or the like adapted to engage into a rotatably mounted and/or supported end and/or end member or assembly of a door curtain.

Preferably an axle member (whether a full or stub axle) of a said complementary door curtain assembly is adapted to pass through the sun gear.

Preferably the transmission is controllable under the action of the functionalities to allow or disallow engagement of the pinion with the internal gearing of the sun gear.

Preferably the pinion is carried from a pivoted member dependent from the assembly, such pivoting allowing the carriage of the pinion into and/or out of mesh with the sun gear.

Preferably the assembly allows by a waisting of its flank for the inset of the complementary mount (optionally under the rotational axis of the sun gear).

In another aspect the present invention consists in a door opener adapted to open and/or close or allow to close a curtain door, the door opener having at least:

at least partial housing assembly that includes support (directly or indirectly) for the remaining features (“the assembly”),

a sun gear carried by the assembly,

a drive member or members to rotate as the sun gear rotates and adapted externally of the assembly to engage and to rotate a complementary door curtain assembly,

a pinion adapted to rotate the sun gear,

an electric motor, and

a transmission from the motor to the pinion selectively by which the pinion rotates responsive to motor movement.

wherein the assembly allows for an inset support thereof (e.g. by a complementary mount) at least in part under part of the assembly when, as is desired, the sun gear of the door opener is to be oriented such that it rotates about a substantially horizontal axis,

and wherein the greatest dimensional extent of the opener in a direction parallel to the rotational axis of the sun gear from the exterior of the sun gear (ignoring the drive member(s)) to the other side of the opener is less than 150 mm.

Preferably the greatest extent is from 125 to 85 mm.

Preferably the greatest extent is from 110 mm to 90 mm.

Preferably the greatest extent is about 100 mm.

Preferably the drive member(s) includes one or more dogs, fingers or the like adapted to engage into a rotatably mounted and/or supported end and/or end member or assembly of a door curtain.

Preferably an axle member (whether a full or stub axle) of a said complementary door curtain assembly is adapted to pass through the sun gear.

Preferably the assembly allows by a waisting of its flank for the inset of the complementary mount (optionally under the rotational axis of the sun gear).

In a further aspect the invention consists in a door opening arrangement including

a (spooled or equivalent) curtain door capable of being rotatably unwound and wound thereby to close and open respectively a door opening of the building,

a door opener engaging in end of the spooled or equivalent curtain door actuable to rotate the door curtain spool or equivalent and

a mount for the door opener from the building, such mount extending substantially to the door opener in a plane or planes substantially normal to the spool or equivalent axis,

wherein the greatest extent of the opener (save for any engagement penetrating into the spooled or equivalent curtain door in a direction parallel to the rotational of the spooled or equivalent curtain door is less than 150 mm).

Preferably the door opener is engaged to said mount in a recessed region thereof on a flank thereof opposite to that flank which has means to functionally engage said spool or equivalent curtain door.

In preferred forms of the present invention the door opener has any of the features hereinafter described with or without reference to the specific of any one or more of the accompanying drawings.

In yet a further aspect the present invention consists in the use of a door opener of any one of the preceding claims in conjunction with a door roll of, for example, a curtain door.

In yet a further aspect the present invention consists in any assembly of a door opening or closing system which involves the use of a door opener or a door opener assembly in accordance with the present invention.

As used herein the term “and/or” means “and” or “or”, or both.

As used herein the term “s” following a noun means the singular and/or plural forms of that noun.

As used herein the term “curtain door” refers to any closure member whether for a window, door, shutter or other closure purpose, whether or not there is edge guiding of the door as it deploys or not, and irrespective of whether or not there is an axle through the door roll or not.

Preferred forms of the present invention will now be described with reference to the accompanying drawings in which

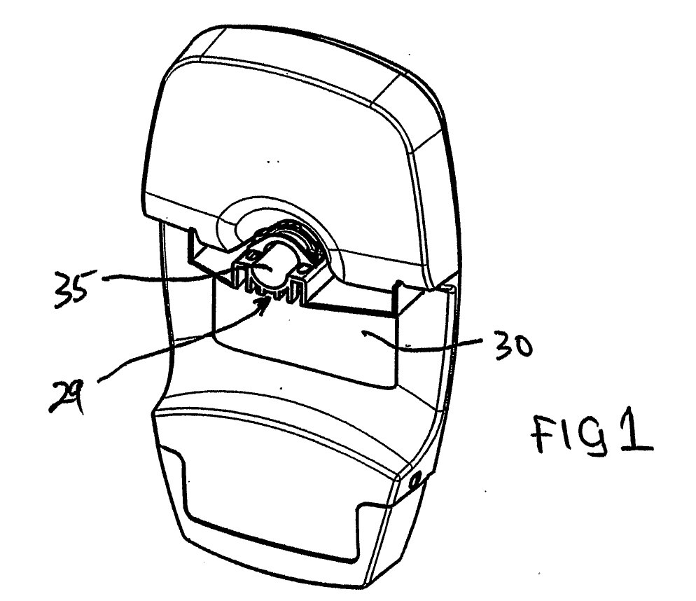

FIG. 1 is a perspective view of a preferred door opener in accordance with the present invention looking at that flank of the door opener having a waist for the purpose of engagement with a mounting member,

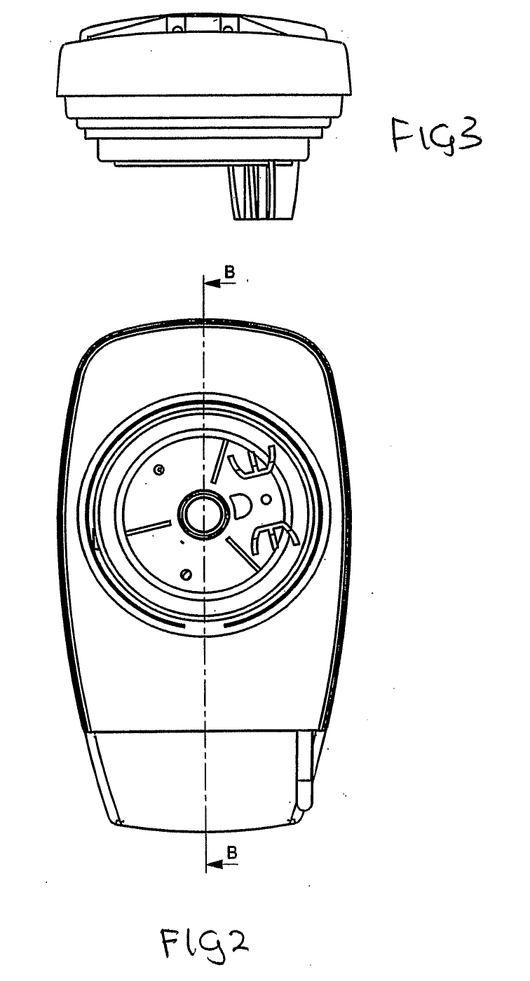

FIG. 2 is a side elevation looking at the other flank to that shown in FIG. 1, there being seen the rotatable output drive with its dogs or fingers that are to engage into the end member of a door roll of a curtain door i.e. a roller door,

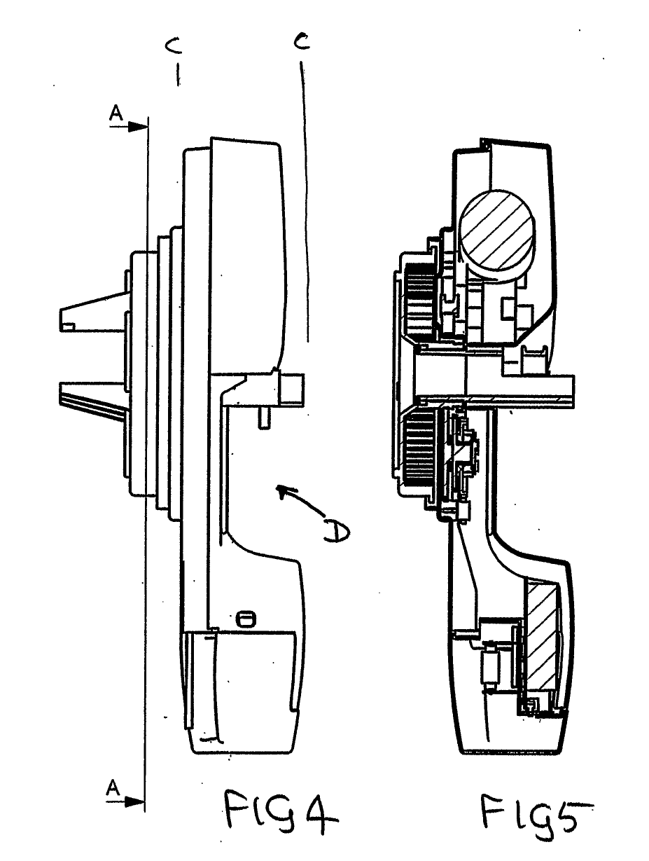

FIG. 3 is a top view of the door opener of FIGS. 1 and 2,

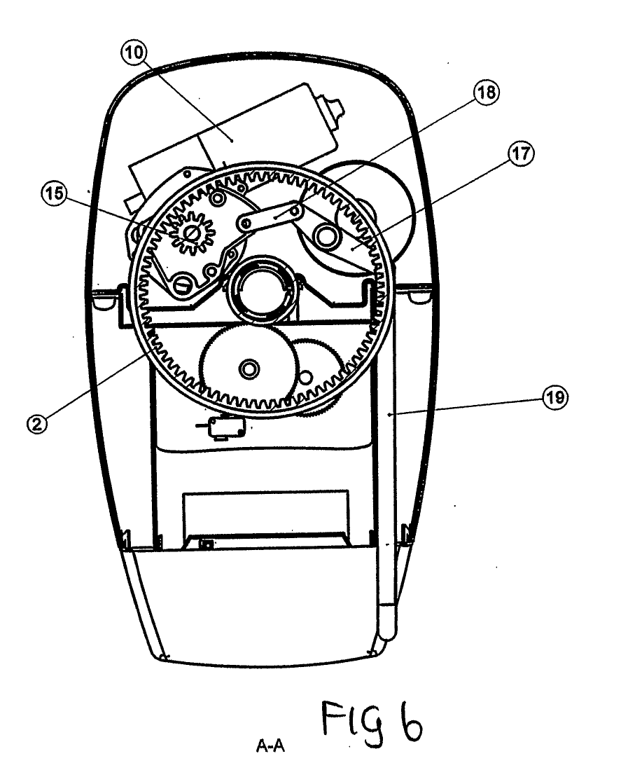

FIG. 4 is a side elevational view of a door opener as in FIGS. 1 to 3 showing the output drive with its dogs to the left and the waisted flank to the right,

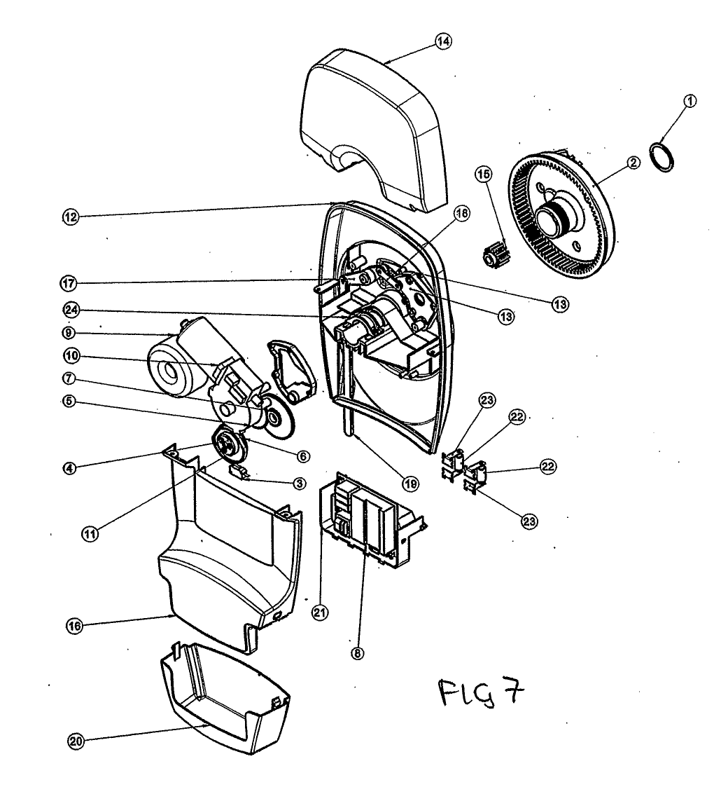

FIG. 5 is a similar view to that of FIG. 4 (the base housing being hidden) but showing the section thereof on the line B-B shown in FIG. 2,

FIG. 6 is a similar view to that of FIG. 2 but showing the section of the door opener at A-A with respect to FIG. 4,

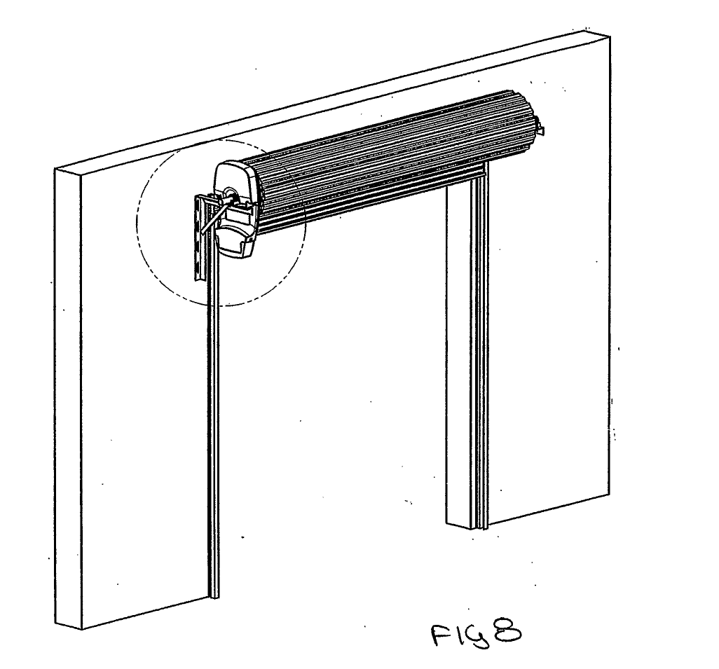

FIG. 7 in a perspective direction similar to that of FIG. 1 shows the door opener in an exploded form, the components of that exploded form being as hereinafter described,

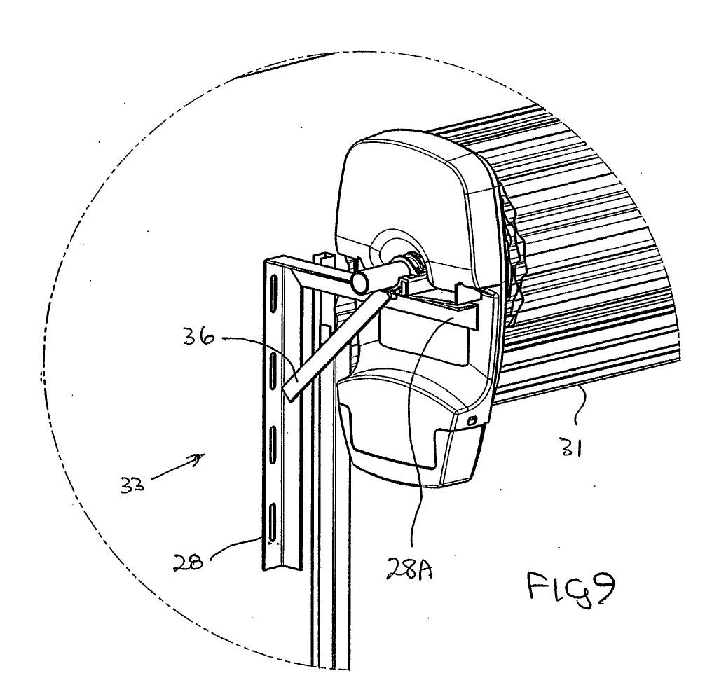

FIG. 8 is a view of a door opened in a dwelling showing a mount engaging the door opener under the rotational axis of the curtain door roll and the output drive member reliant upon the waisted flank of the narrow door opener,

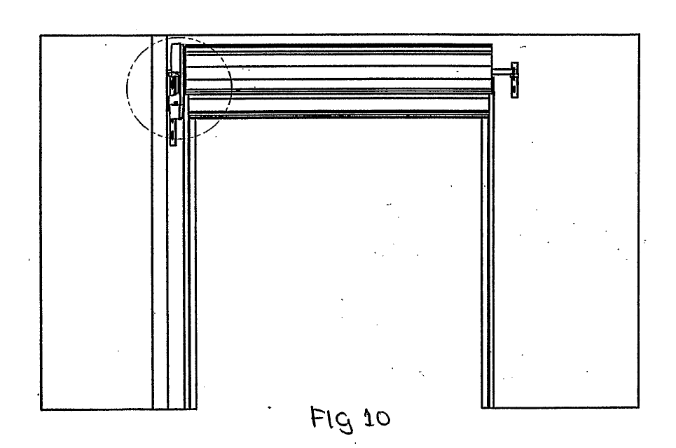

FIG. 9 is an enlargement of the mounting arrangement shown in FIG. 8,

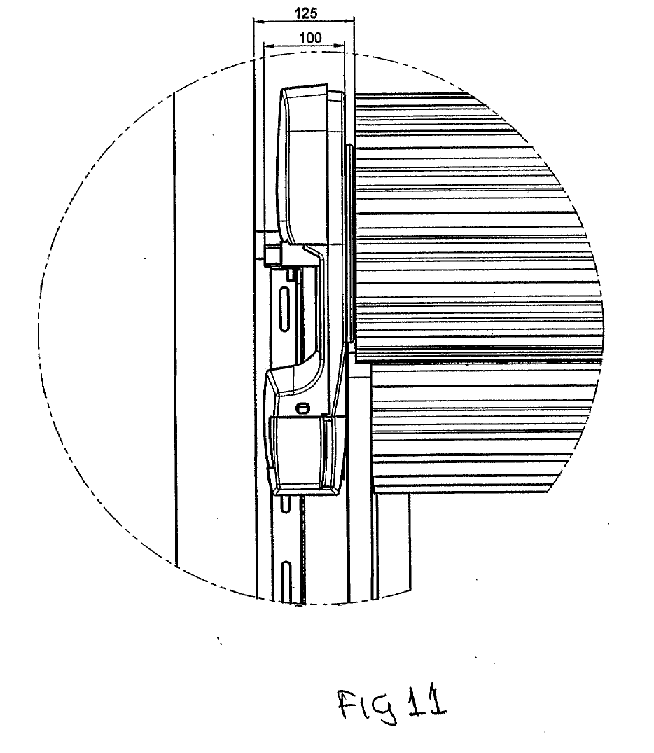

FIG. 10 is an elevational view of the arrangement shown in FIG. 8,

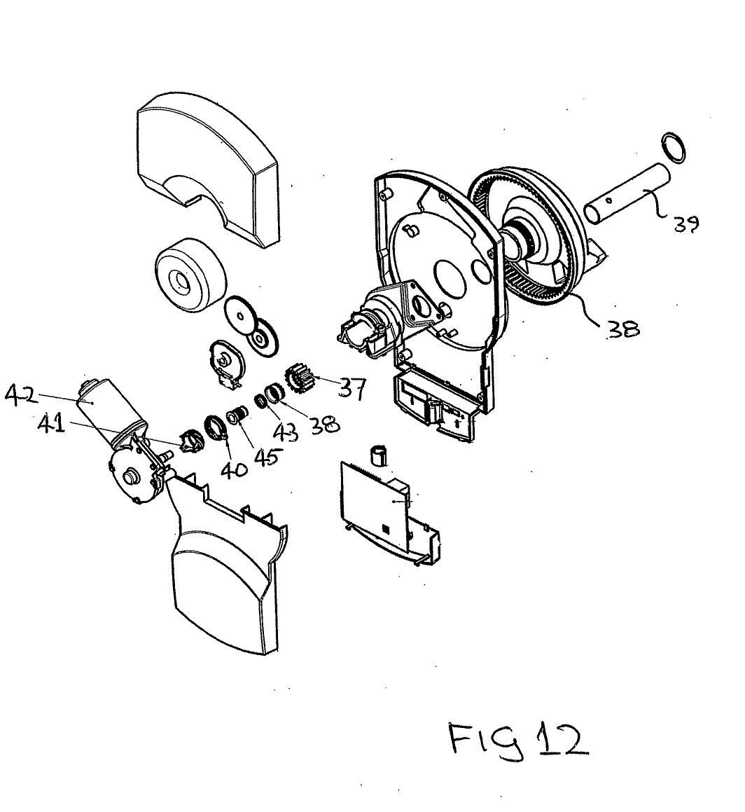

FIG. 11 is an enlargement of the door opener and the end of the door curtain roll, and

FIG. 12 shows an exploded view of a clutched transmission door opener similarly with the waisted flank features previously disclosed.

In the preferred form of the present invention shown in FIGS. 1 to 11 the maximum dimension from C to C (see FIG. 4) is waisted at D (see FIG. 4) for the bracket support.

The maximum distance C-C is less than 200 mm and preferably is less than 150 mm. An ideal distance to maximise its flexibility of installation is of the order of about 100 mm or less.

The exploded view shows the preferred components of such a door opener.

| Item No. | Description |
|---|---|
| 1 | Plastic sun ring retainer clip |
| 2 | Nylon sun gear |
| 3 | A micro switch |
| 4 | Gear cover |
| 5 | A plastic gear idler set |
| 6 | A gear |
| 7 | A gear |
| 8 | A PCB |
| 9 | A DC transformer |
| 10 | Electric motor |
| 11 | Micro switch cam of PP plastic |
| 12 | Base housing |
| 13 | Motor mount plate |
| 14 | PP plastic housing cover |
| 15 | Pinion (e.g. of aluminium) |
| 16 | PP plastic lower cover |
| 17 | Motor mount plate lever |
| 18 | Motor engage link |
| 19 | Motor engage push rod link |
| 20 | Diffuser |
| 21 | Light base plate cover panel |
| 22 | Lightbulb |
| 23 | Light terminal |
| 24 | Bolt |
| 25 | Clamp bracket |
| 26 | Motor mount plate |

As can be seen a mounting 27 can have an arm 28 thereof adapted to engage in the waisted region D (see FIG. 4) such that the arm 28 is engaged by appropriate fixing as well as inter-engagements with the region 29 as well as, if desired, to the face 30 (see FIG. 1). This intrusion of the arm 28A of the mounting bracket 28 into the overall envelope of the narrow door opener (in the C-C expanse shown in FIG. 4) means that, even mounted, there is not an expansive dimension, thus enabling a butt wall or true wall to be positioned very close to the end of a door curtain roll 31 notwithstanding the need to position the door opener 32 and its mount from the wall 33.

In evolving such a door opener, it is to be seen that the rotational axis of the motor 10 is in a plane normal to the axle 34 of the curtain roll 31 which is to extend through the passageway 35 allowed by the door opener (for alignment and weight bearing purposes) and be supported directly over the mounting arm 28A preferably with its gusseted reinforcement 36.

A feature, as can be seen is that the pivoted motor mounting plate 13 carries the sub-assembly which includes the motor and items associated therewith in the exploded view of FIG. 7 as well as allowing the drive to extend through to the pinion 15. Consequently with the linkages 17 and 18, there is the prospect of the pinion 15 being brought into or out of mesh with the internal gearing of the sun gear 2. Such de-meshing features are known in other door openers but here the arrangement depicted allows such an arrangement in the narrow expanse of the distance C-C and the positioning of the functional features still allows the waisting D for the purpose stated.

The covers shown in the drawings (e.g. 14 and 16) form a rain resistant seal with the base 12. The seal(s) can also at least in part retain, for example, cover(s) 14 and/or 16 to the base 12. Preferably two screws are used to retain both covers and are easily accessible once installed even in tight clearance situations. Diffuser 20 clip fits to cover 16 to undertake the remainder of the assembly.

In the embodiment of the exploded assembly of figure assembly as shown, the pinion 37, when the drive to it is enabled by the clutch mechanism, has the effect of rotating the sun gear 38 with its driving component typified by the extension tubes 39.

A manual input is adapted to clutch the drive by its action on component 40 which, by virtue of its helical engagement with component 41 disengages. Item 41 (clutch collar) is moved in a linear direction away from the pinion gear 37. Item 41 engages a shoulder on shaft dog 38 and disengages it from the pinion gear 37. On releasing the manual input, or any latching thereof e.g. of cord and the tension on clutch lever 40, clutch collar 41 is also free to move back towards the pinion gear 15. The shaft dog 38 with the assistance of spring 43 is able to reengage with pinion gear 37 at the next rotational alignment. The motor 42 drives sleeve 45 which drives shaft dog 38 and then the pinion gear 37.

Such a telescopic arrangement as contemplated allows for the maximum flank to flank dimension, ignoring the extension fingers of the final drive (i.e. which are usually received within the end of the door roll), to be very thin, thus enabling usage of the opener in confined spaces notwithstanding a desire, reliant on the waisted region (“D” or its equivalent).

It can be seen that the clutch includes:
a dog engagement
a bias to dog engagement
a telescoping against the bias when clutched
a helical interaction to provide telescoping in one or either direction
a manual input to provide the clutched condition.

It is believed therefore, door openers in accordance with the present invention, will find widespread acceptance.

1. A door opener which has a capability of being mounted in a small space between the end of a door roll of, for example, a curtain door and any impediment spaced therefrom, such door opener having provision whereby, despite its need for mounting and/or its lateral extent in the direction of the rotational axis of its output drive member, is and will be less than 200 mm.

2. A door opener of claim 1 wherein the expanse of the un-mounted opener itself is less than 150 mm.

3. A door opener of a kind having a rotatable output member adapted to engage a door to be opened or closed, said output member having an axis of rotation which in use will be at least substantially horizontal and transverse to the longitudinal extent thereof which is in use will be substantially vertical,
wherein the opener has its transverse extent in that direction parallel to said axis of rotation less than its transverse extent normal thereto and less than its longitudinal extent,
and wherein on that flank of the opener opposite the flank with the output member there is a waisting at a region adapted to receive a or the mount for the opener.

4. A door opener of claim 3 wherein the transverse extent parallel to said axis of rotation is less than 150 mm.

5. A door opening arrangement including
a (cored, spooled, axled or equivalent) curtain door assembly capable of being rotatably unwound and wound, thereby to close and open respectively a door opening of a building,
a door opener engaging an end of the curtain door assembly capable of being initiated to cause the curtain door assembly to unwind and/or wind, and
a mount for the door opener from the building
wherein the door opener has a lateral parallel to the wind/unwind axis of the curtain door assembly less than 150 mm.

6. An arrangement of claim 5 wherein the mount is into a waisted region of one flank of the door opener.

7. A door opener adapted to open and/or close or allow to close a curtain door, the door opener having at least:
at least partial housing assembly that includes support (directly or indirectly) for the remaining features (“the assembly”),
a sun gear carried by the assembly,
a drive member or members to rotate as the sun gear rotates and adapted externally of the assembly to engage and to rotate a complementary door curtain assembly,
a pinion adapted to rotate the sun gear,
an electric motor,
a transmission from the motor to the pinion by which the pinion rotates responsive to motor movement, and
control and limit functionalities for the motor, the transmission and/or the sun gear/pinion interaction whereby the drive of the sun gear, one way and/or the other in a rotational sense, and (optionally) the limiting of rotation thereof in at least one rotational sense, is caused, allowed and/or controlled by (a) signal inputs alone or (b) a mixture of set up input(s) and signal input(s),
wherein the assembly allows for an inset support thereof (e.g. by a complementary mount) at least in part under part of the assembly when, as is desired, the sun gear of the door opener is to be oriented such that it rotates about a substantially horizontal axis,
and wherein the greatest dimensional extent of the opener in a direction parallel to the rotational axis of the sun gear from the exterior of the sun gear (ignoring the drive member(s)) to 15 the other side of the opener is less than 150 mm.

8. A door opener of claim 7 wherein the greatest extent is from 125 to 85 mm.

9. A door opener of claim 7 wherein the greatest extent is from 110 mm to 90 mm.

10. A door opener of claim 7 wherein the greatest extent is about 100 mm.

11. A door opener of claim 7 wherein the drive member(s) includes one or more dogs, fingers or the like adapted to engage into a rotatably mounted and/or supported end and/or end member or assembly of a door curtain.

12. A door opener of claim 7, wherein an axle member (whether a full or stub axle) of a said complementary door curtain assembly is adapted to pass through the sun gear.

13. A door opener of claim 7 wherein the transmission is controllable under the action of the functionalities to allow or disallow engagement of the pinion with the internal gearing of the sun gear.

14. A door opener of claim 7 wherein the pinion is carried from a pivoted member dependent from the assembly, such pivoting allowing the carriage of the pinion into and/or out of mesh with the sun gear.

15. A door opener of claim 7 wherein the assembly allows by a waisting of its flank for the inset of the complementary mount (optionally under the rotational axis of the sun gear).

16. A door opener adapted to open and/or close or allow to close a curtain door, the door opener having at least:
at least partial housing assembly that includes support (directly or indirectly) for the remaining features (“the assembly”),
a sun gear carried by the assembly,
a drive member or members to rotate as the sun gear rotates and adapted externally of the assembly to engage and to rotate a complementary door curtain assembly,
a pinion adapted to rotate the sun gear,
an electric motor, and
a transmission from the motor to the pinion selectively by which the pinion rotates responsive to motor movement,
wherein the assembly allows for an inset support thereof (e.g. by a complementary mount) at least in part under part of the assembly when, as is desired, the sun gear of the door opener is to be oriented such that it rotates about a substantially horizontal axis,
and wherein the greatest dimensional extent of the opener in a direction parallel to the rotational axis of the sun gear from the exterior of the sun gear (ignoring the drive member(s)) to the other side of the opener is less than 150 mm.

17. A door opener of claim 16 wherein the greatest extent is from 125 to 85 mm.

18. A door opener of claim 16 wherein the greatest extent is from 110 mm to 90 mm.

19. A door opener of claim 16 wherein the greatest extent is about 100 mm.

20. A door opener of claim 16 wherein the drive member(s) includes one or more dogs, fingers or the like adapted to engage into a rotatably mounted and/or supported end and/or end member or assembly of a door curtain.

21. A door opener of claim 16 an axle member (whether a full or stub axle) of a said complementary door curtain assembly is adapted to pass through the sun gear.

22. A door opener of claim 16 wherein the assembly allows by a waisting of its flank for the inset of the complementary mount (optionally under the rotational axis of the sun gear).

23. A door opening arrangement including
a (spooled or equivalent) curtain door capable of being rotatably unwound and wound thereby to close and open respectively a door opening of the building,
a door opener engaging in end of the spooled or equivalent curtain door actuable to rotate the door curtain spool or equivalent and
a mount for the door opener from the building, such mount extending substantially to the door opener in a plane or planes substantially normal to the spool or equivalent axis,
wherein the greatest extent of the opener (save for any engagement penetrating into the spooled or equivalent curtain door in a direction parallel to the rotational of the spooled or equivalent curtain door) is less than 150 mm.

24. An arrangement of claim 23 wherein the door opener is engaged to said mount in a recessed region thereof on a flank thereof opposite to that flank which has means to functionally engage said spool or equivalent curtain door.

26. (canceled)

27. (canceled)
